(19) United States
(12) Patent Application Publication
(10) Pub. No.: US 2005/0056608 A1
(43) Pub. Date: Mar. 17, 2005

(54) Bottle insert for storing and dispensing baby formula

(76) Inventor: Milton Scott Nesin, Manvel, TX (US)

Correspondence Address: Mr. M. Scott Nesin, 9500 Live Oak Court, Manvel, TX, 77578, US

(21) Appl. No.: 10/662,504

(22) Filed: Sep. 15, 2003

(51) Int. Cl. A61J 11/00; A61J 9/00; B65D 23/12

(52) U.S. Cl. 215/11.1; 215/386

(57) ABSTRACT

A nursing bottle insert that stores a measured amount of powder. The insert resides inside the bottle along with a correspondingly measured amount of water for the sealed powder to mix with. The powder and the water are allowed to mix when desired by applying a force external to the bottle.

### CROSS-REFERENCE TO RELATED APPLICATIONS

Not applicable.

### FEDERALLY SPONSORED RESEARCH OR DEVELOPMENT

Not applicable.

### SEQUENCE LISTING

Not applicable.

### BACKGROUND—FIELD OF INVENTION

This invention relates to infant feeding bottles, and particularly to those of a type used with powdered milk.

### BACKGROUND—DESCRIPTION OF PRIOR ART

In a commonly used arrangement for bottle-feeding infants, the bottle is filled with water, to which powdered milk is added only when the baby is to be fed. That way, especially during car trips or visits away from home, or on other occasions when refrigeration may not be available for many hours at a time, the baby can be fed at any time without worrying about whether the milk has spoiled. Many hours can pass between bottle preparation and the feeding of the baby, without requiring refrigeration of the bottle.

When feeding time arrives, the nipple is removed from the bottle, a measured amount of powder is added to the water through the now-open mouth of the bottle, the nipple is reinstalled, and the bottle is shaken to mix the contents.

In such arrangements, the powder is generally stored in a can or in a similar container, often with a measuring spoon or scoop supplied within the same container. The can or other container may be carried, along with one or more water-filled bottles. Just before a feeding, the scoop is used to measure the proper amount of powder to add to the bottle contents.

A can of powdered milk is somewhat heavy and bulky to carry away from home. Accordingly, smaller containers for milk powder have been provided which are washable and refillable. A known design has three chambers, each separately openable and each carrying a measure of powdered milk suitable for a single bottle. However, such a container still must be carried separate and apart from the bottles, and additional inconveniences arise when the number of bottles to be used does not match the number of storage chambers in the container, especially when the number of bottles exceed the number of storage chambers.

In applications where a formula prepared by mixing two constituents has a short shelf-life or where the quantities, quality or sterility of the constituents is an important consideration in the preparation of the formula, a single container which could separately store the two constituents until the mixed formula is to be dispensed, permit the two constituents to be mixed in the container and permit the mixed formula to be dispensed from the container would be useful.

U.S. Pat. No. 5,411,155 to Gordon et al. (1995) discloses a protective nipple cover with a chamber for storing a measured amount of powder for the bottle to be mixed when needed; however, the powder is stored externally to the bottle. The bottle must be opened to add the powder, thus exposing the contents of the bottle to accidental contamination. It also requires two hands and the caregiver's full attention to add the powder without spilling either the water or the powder.

U.S. Pat. Nos. 6,045,254 to Inbar et al. (1997), 6,575,208 to Igal et al. (2001), and patent application 20010039977 to Igal et al. (2001) all disclose a complex bottle having two chambers, one that can hold water and another that can hold powder. A rotating displaceable partition between the two chambers allows the components to mix. The two chambers are integral parts of the bottle, requiring the caregiver to purchase the bottle as a unit, made more expensive by the numerous and complex moving parts. This does not allow the caregiver to take advantage of bottles already in their possession. Furthermore, it is designed for pre-packaged single use. The bottle assembly, with its numerous parts and required tolerances, would impede proper washing and extra care would be needed to ensure that all surfaces and crevices are completely cleansed after each use should the caretaker attempt to reuse the disposable bottle.

Several other types of two chambered bottles have been proposed for seemingly industrial purposes—for example U.S. Pat. No. 5,692,644 to Gueret (1995), and patent applications 20020066677 and 20020066679, both (2001) to Moscovitz. Each involves a complex bottle or apparatus unsuited to administering infant formula.

Inserts for baby bottles have been proposed for purposes unrelated to storing and releasing infant formula. U.S. Pat. No. 4,915,242 to Marte (1989) shows a fixed insert that releases medicines or vitamins at a slow rate into the nipple as the infant nurses on a pre-mixed formula. Marte's insert does not have a sealed chamber to store material; the material constantly communicates with the liquid contents.

U.S. Pat. No. 6,041,951 to Blum (2000) shows a fixed insert that allows the infant to nurse regardless of the bottle orientation. It is not designed for storing and releasing a substance.

Pre-measuring infant powder and water, storing them separately until needed, and the ability to mix the components quickly with a minimum of complexity, handling, attention, chance of contamination or spilling, cleanup, and waste due to single use, while utilizing the bottles, collars, and nipples already in possession, are desirable objectives. None of the above proposals provide an acceptable solution.

### BRIEF SUMMARY OF THE INVENTION

A reusable bottle insert that stores a pre-measured amount of infant formula inside a feeding bottle also having a pre-measured amount of water and allows the powder and water to mix when desired.

The bottle and insert can be prepared ahead of time in anticipation of a later need. This allows the caregiver to prepare the bottle in a more controlled environment, facilitating cleanliness and accurate measurements.

The insert containing the powder resides inside the bottle and releases the powder into the water when a force external to the bottle is applied. This allows the bottle to remain sealed after preparation, ready for mixing, for as long as the sterility of the environment in which it was prepared allows. As it is not necessary to open the bottle to initiate the mixing, a minimum of handling and attention is required from the caregiver, and a significant opportunity for contamination and spilling is eliminated.

The insert is inexpensive due to its compatibility with bottles the caregiver already possesses, its reusability, and its few parts. Its simple operation and lack of moving parts will also facilitate its cleaning.

The bottle insert of the invention fulfills the desired objectives and provides many advantages not present in the prior art.

### BRIEF DESCRIPTION OF THE DRAWINGS

In the drawings, closely related figures have the same number but different alphabetic suffixes. All sections are vertical through the center.

FIG. 1A is an exploded perspective view of a typical prior art feeding bottle, collar, and nipple.

FIG. 1B is a section view of a prior art bottle.

FIG. 1C is a section view of a prior art nipple.

FIG. 1D is a section view of a prior art collar.

FIG. 1E is a section view of a prior art nipple mated to a prior art collar.

FIG. 1F is a section view of a prior art one-piece nipple.

FIG. 1G is a section view of a prior art nipple, collar, and bottle assembly.

FIG. 1H is a section view of a prior art protective nipple cover.

FIG. 1I is a section view of a prior art protective nipple cover mated with a prior art bottle assembly.

FIG. 1J is a detail section view of a prior art protective nipple cover and collar connection.

FIG. 2A shows a one-piece embodiment of the container insert in perspective.

FIG. 2B is a section view of a one-piece container insert.

FIG. 2C is a detail view of a one-piece container insert in perspective.

FIG. 2D is a section view of a one-piece container insert filled with a material.

FIG. 2E is a section view of a one-piece container insert filled with a material and sealed with a nipple-collar assembly.

FIG. 2F is a section view of a one-piece container insert in the storing position.

FIG. 2G is a section view of a one-piece container insert in the releasing position.

FIG. 3A shows an exploded two-piece embodiment of the container insert in perspective.

FIG. 3B is a section view of a two-piece container insert body.

FIG. 3C is a detail view of a two-piece container insert body in perspective.

FIG. 3D is a section view of an assembled two-piece container insert.

FIG. 3E is a detail section view of an assembled two-piece container insert.

FIG. 3F is a section view of a two-piece container insert body mated with a nipple-collar assembly.

FIG. 3G is a section view of a two-piece container insert body mated with a nipple-collar assembly, inverted, and filled with a material.

FIG. 3H is a section view of a two-piece container insert body mated with a nipple-collar assembly, inverted, filled with a material, and sealed with a cap.

FIG. 3I is a section view of a two-piece container insert in the storing position.

FIG. 3J is a section view of a two-piece container insert in the releasing position.

FIG. 4A shows the preferred two-piece container insert, exploded and perspective.

FIG. 4B is a section view of the preferred two-piece container insert body.

FIG. 4C is a detail view of the preferred two-piece container insert body in perspective.

FIG. 4D is a section view of the preferred two-piece container insert assembled.

FIG. 4E is a detail section view of the preferred two-piece container insert assembled.

FIG. 4F is a section view of the preferred two-piece container insert body mated with a nipple-collar assembly.

FIG. 4G is a section view of the preferred two-piece container insert body mated with a nipple-collar assembly, inverted, and filled with a material.

FIG. 4H is a section view of the preferred two-piece container insert body mated with a nipple-collar assembly, inverted, filled with a material, and sealed with a cap.

FIG. 4I is a section view of the preferred two-piece container insert, filled and mated with a nipple-collar assembly, with a protective nipple cover.

FIG. 4J is a section view of the preferred two-piece container insert in the storing position.

FIG. 4K is a section view of the preferred two-piece container insert in the intermediate releasing position.

FIG. 4L is a section view of the preferred two-piece container insert in the full releasing position.

FIG. 5A shows an exploded three-piece embodiment of the container insert in perspective.

FIG. 5B is a section view of a three-piece container insert body.

FIG. 5C is a detail view of a three-piece container insert body in perspective.

FIG. 5D is a detail view of a three-piece container insert sealing member in perspective.

FIG. 5E is a section view of an assembled three-piece container insert.

FIG. 5F is a detail section view of an assembled three-piece container insert.

FIG. 5G is a section view of partially assembled three-piece container insert filled with a material.

FIG. 5H is a section view of fully assembled three-piece container insert filled with a material.

FIG. 5I is a section view of a three-piece container insert in the storing position.

FIG. 6A is a section view in perspective of a one-piece container insert filled and packaged for immediate use.

FIG. 6B is a section view in perspective of the preferred container insert filled and packaged for immediate use.

FIG. 6C is a section view in perspective of a three-piece container insert filled and packaged for immediate use.

### REFERENCE NUMERALS IN DRAWINGS

Prior Art Bottle Elements

| | | | |
|---|---|---|---|
| 10 | bottle | | |
| 11 | outer wall | 12 | closed end |
| 13 | open end | 14 | opening |
| 15 | threads | | |

Prior Art Nipple Elements

| | | | |
|---|---|---|---|
| 20 | nipple | | |
| 21 | flange | 22 | neck |
| 23 | retaining rib | 24 | closed end |
| 26 | opening | 27 | cavity |
| 28 | perforations | | |

Prior Art Collar Elements

| | | | |
|---|---|---|---|
| 30 | collar | | |
| 31 | side | 32 | end |
| 33 | opening | 34 | threads |
| 35 | flange | 36 | opening |
| 37 | retaining rib | | |
| 50 | nipple-collar assembly | 51 | one-piece nipple |

Prior Art Cover Elements

| | | | |
|---|---|---|---|
| 52 | cover | | |
| 53 | open end | 54 | opening |
| 55 | closed end | 56 | recess |
| 57 | side | 58 | retaining rib |
| 60 | bottle assembly | | |
| 61 | liquid | 62 | material |

Common Insert Elements

| | | | |
|---|---|---|---|
| 70 | graduations | 71 | packaging |
| 72 | castellations | 73 | rounded corners |
| 74 | sealing member | 75 | pull tab |

One Piece Insert Elements

| | | | |
|---|---|---|---|
| 100 | container insert | | |
| 101 | outer wall | 102 | closed end |
| 104 | open end | 105 | opening |

Two Piece Insert Elements

| | | | |
|---|---|---|---|
| 200 | insert body | | |
| 201 | outer wall | 202 | open end |
| 203 | opening | 204 | open end |
| 205 | opening | 208 | rib |
| 210 | sealing member | | |
| 211 | side | 212 | rib |
| 250 | container insert assembly | | |

Preferred Insert Elements

| | | | |
|---|---|---|---|
| 300 | insert body | 301 | outer wall |
| 302 | open end | 303 | opening |
| 304 | open end | 305 | opening |
| 308 | flange | 309 | sealing member |
| 310 | sealing member | 312 | side |
| 313 | flange | 314 | groove |
| 315 | pushrod | 316 | bulb |
| 350 | container insert assembly | | |

Three Piece Insert Elements

| | | | |
|---|---|---|---|
| 400 | insert body | | |
| 401 | outer wall | 403 | opening |
| 406 | castellations | 408 | flange |
| 410 | sealing member | 412 | side |
| 413 | flange | 414 | groove |
| 415 | fin | 416 | castellations |
| 450 | container insert assembly | | |

### DETAILED DESCRIPTION OF THE INVENTION

For readiest understanding of the invention, it is helpful to describe a prior art feeding bottle in some detail.

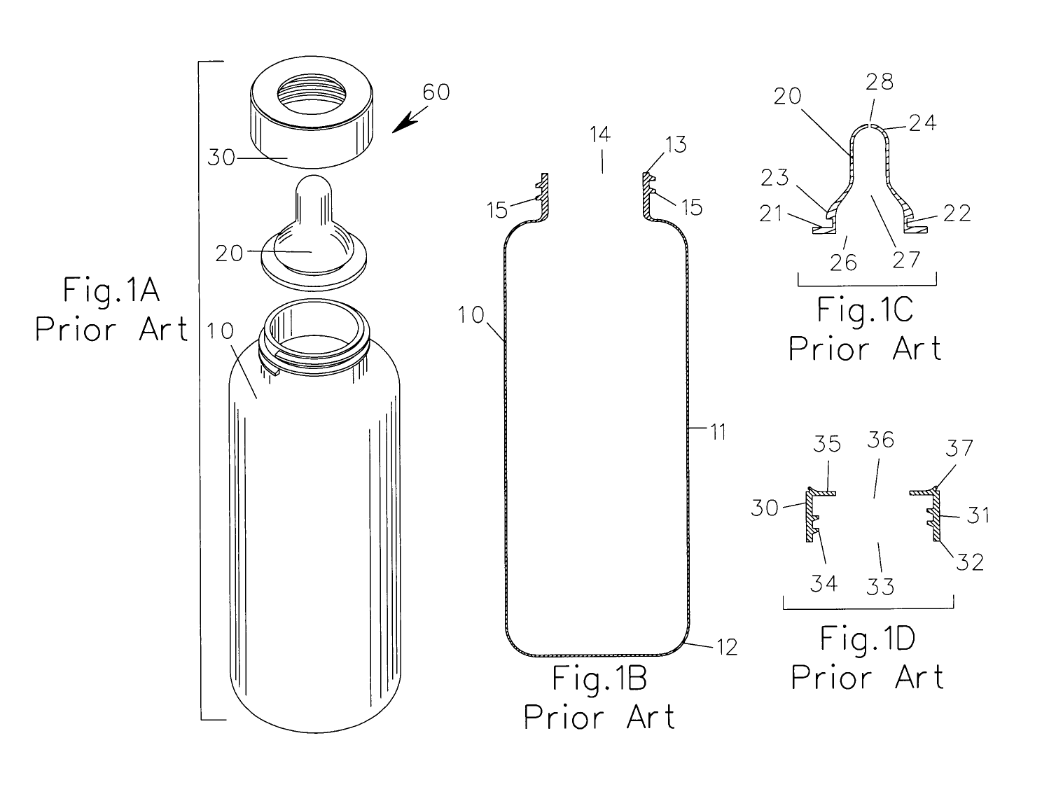

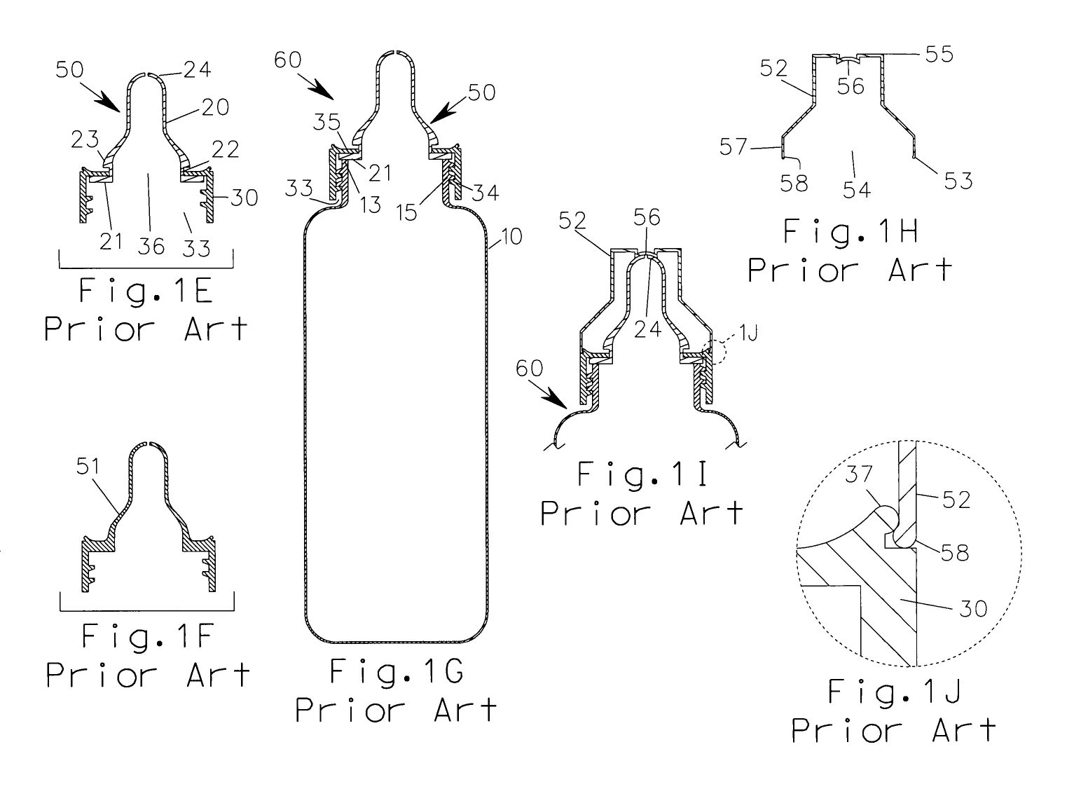

Thus, in FIGS. 1A to 1D, the components of a typical prior art bottle assembly 60 are shown, comprising a bottle 10, a nipple 20, and a collar 30 (FIG. 1A). Bottle 10 (FIG. 1B) is formed of plastic or glass. Bottle 10 is of hollow construction, with outer wall 11 closed off at closed end 12, and with an opening 14 at open end 13. Open end 13 has exterior threads 15. Nipple 20 (FIG. 1C), formed of silicone or latex, has an outward flange 21. Nipple 20 has a neck 22 formed by flange 21 and a retaining rib 23. Nipple 20 has a closed end 24 with a plurality of perforations 28. Nipple 20 is of hollow construction, forming a cavity 27. Flange 21 has an opening 26 that allows a liquid (not shown) to be drawn into cavity 27 and out through perforations 28. Collar 30 (FIG. 1D), which is formed of plastic, has a side 31 with interior threads 34. Collar 30 has an inward flange 35 with an opening 36. Collar 30 has an end 32, with opening 33. Flange 35 has an outward facing retaining rib 37.

FIG. 1E shows a section of a nipple 20 mated with a collar 30, forming a nipple-collar assembly 50. Closed end 24 is drawn through opening 33 and opening 36, such that neck 22 is nested in opening 36 and nipple 20 is retained in this position by flange 21 and retaining rib 23.

FIG. 1F shows a section of a prior art one-piece nipple 51, which is formed of rubber and plastic in a permanent bond. One-piece nipple 51 may be used in place of a two-piece nipple-collar assembly (not shown).

FIG. 1G shows a bottle 10 mated to a nipple-collar assembly 50, forming a bottle assembly 60. Open end 13 is inserted into opening 33, and threads 15 are engaged with threads 34. Open end 13 and flange 21, held together with pressure from flange 35, form a liquid-proof seal.

FIG. 1H shows a section of an optional prior art cover 52, which is formed of plastic. Cover 52 has an open end 53 with opening 54. Cover 52 has a closed end 55, with a centrally located recess 56 on the interior side. Cover 52 has a side 57 with an inward retaining rib 58.

FIG. 1I shows a section of a cover 52 mated to a bottle assembly 60 (see FIG. 1J). Recess 56 conforms to and covers closed end 24.

FIG. 1J shows the details of retaining a cover 52 on a collar 30. An inward retaining rib 58 on cover 52 is engaged with an outward retaining rib 37 on collar 30, forming a snap closure.

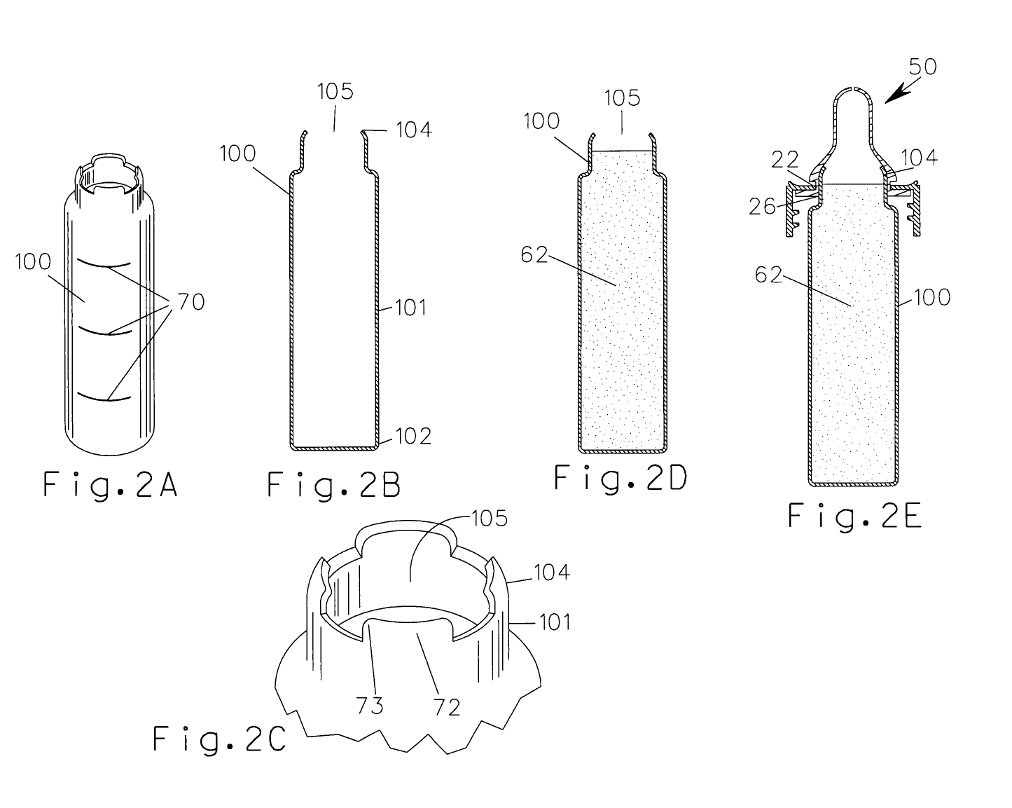

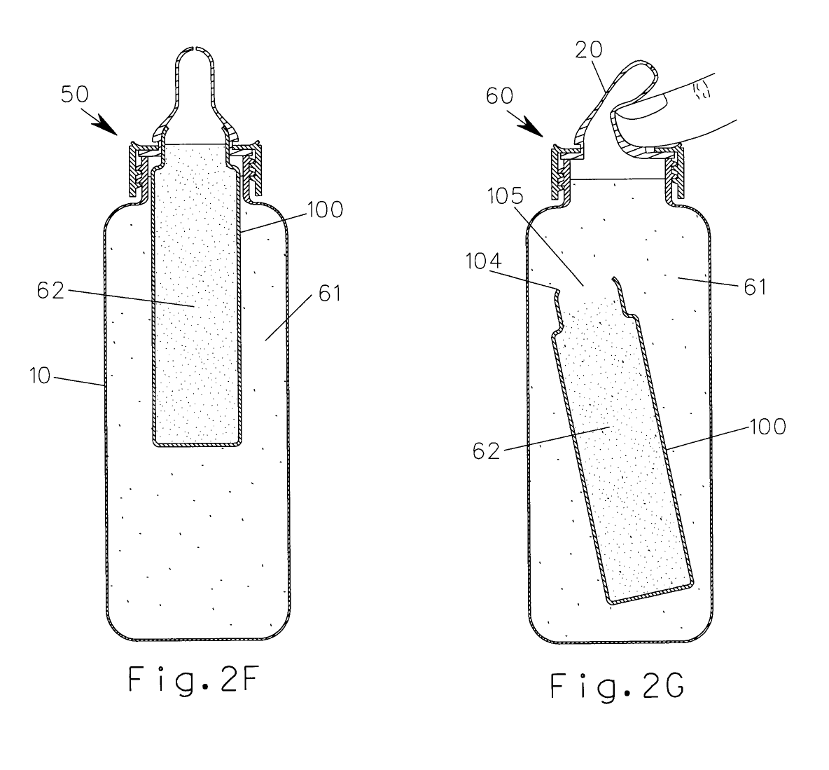

A one-piece example of the invention is shown in FIGS. 2A to 2D. A container insert 100 (FIG. 2A) of hollow construction, cylindrical in shape, formed of plastic, preferably transparent, with a plurality of graduations 70 on the outside. Container insert 100 has an outer wall 101 (FIG. 2B), closed off at closed end 102, with an opening 105 at open end 104. Outer wall 101 is curved slightly inward at open end 104 (FIGS. 2B and 2C). Outer wall 101 has a plurality of slight castellations 72 with rounded corners 73 along the edge of opening 105 (FIG. 2C). Container insert 100 can be filled with a material 62 through opening 105 (FIG. 2D).

FIGS. 2E to 2G show a one-piece container insert 100 in use. Container insert 100, filled with a material 62, is mated with a nipple-collar assembly 50 by inserting open end 104 into opening 26 (FIG. 2E). A liquid-proof seal is created by open end 104 and neck 22, protecting material 62. Nipple-collar assembly 50, with container insert 100 and material 62, is mated to a bottle 10, which also contains a liquid 61 (FIG. 2F). This is the storage position for container insert 100. Liquid 61 and material 62 cannot communicate and may be stored separately in this configuration, ready for mixing, for as long as the sterility of the environment in which it was prepared allows. When mixing is desired, nipple 20 is depressed with enough force to dislodge container insert 100 from nipple 20 (FIG. 2G). Open end 104 is unsealed, allowing material 62 and liquid 61 to mix through opening 105. After agitating bottle assembly 60 the mixture can be administered.

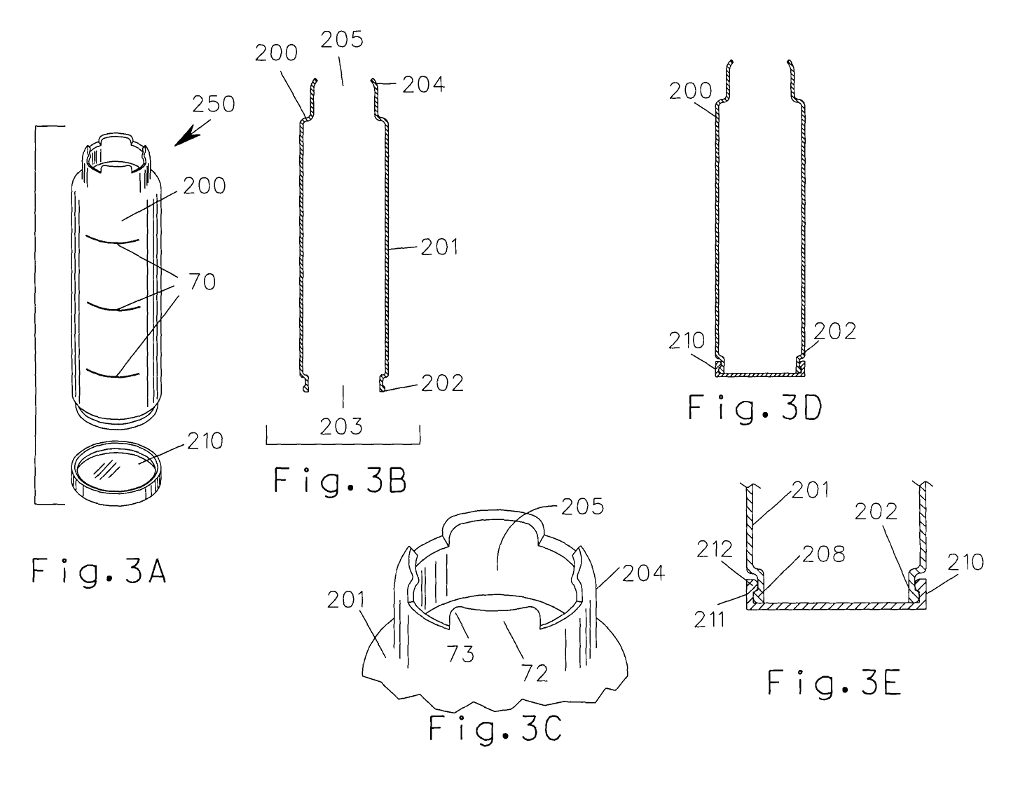

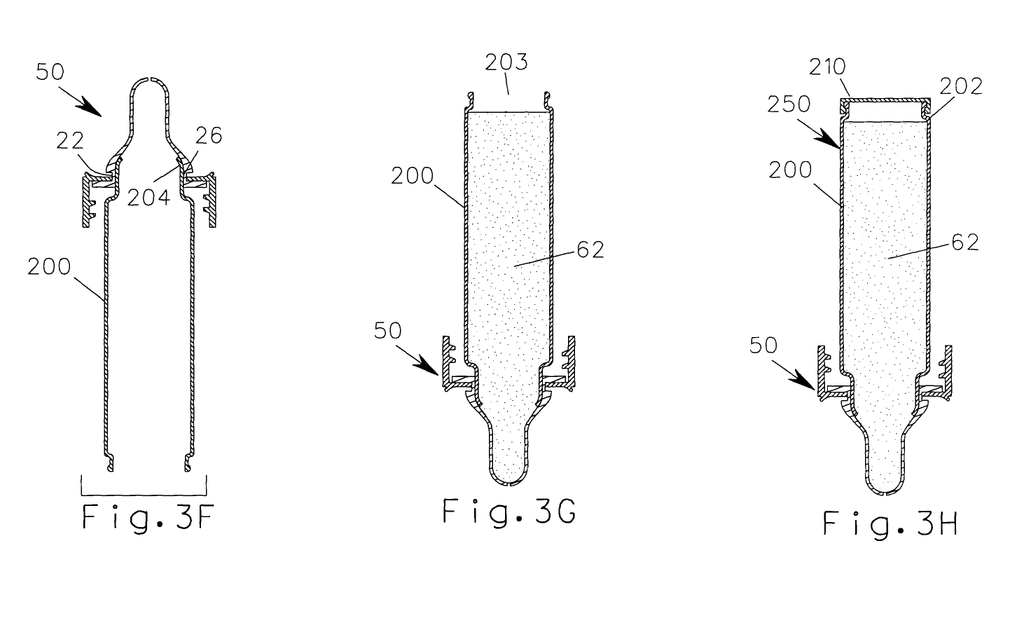

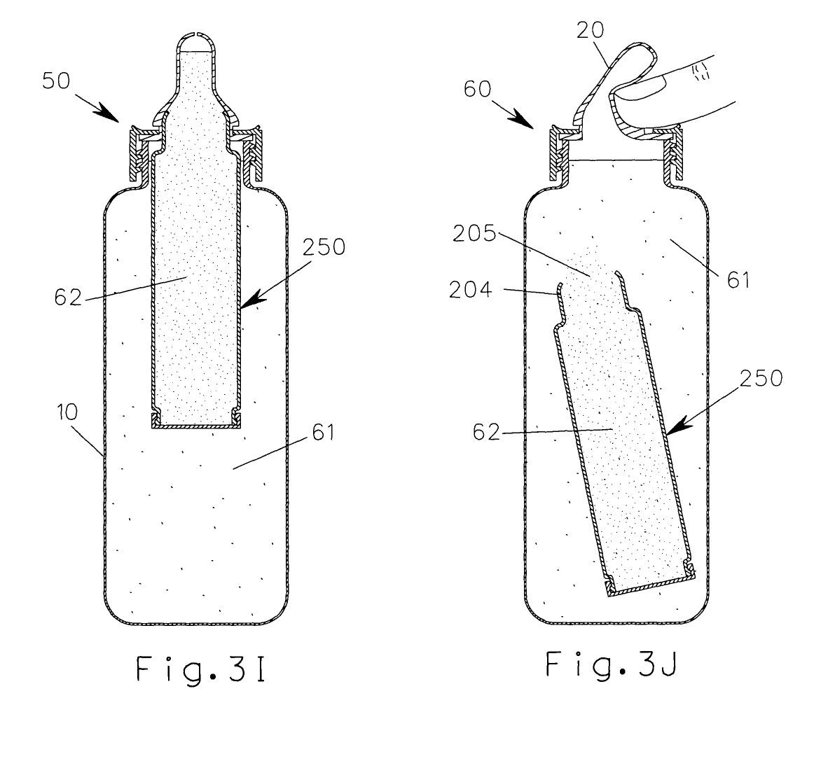

A two-piece example of the invention is shown in FIGS. 3A to 3E. A container insert assembly 250 (FIG. 3A), comprising an insert body 200 of hollow construction, cylindrical in shape, formed of plastic, preferably transparent, with a plurality of graduations 70 on the outside, and a sealing member 210 shaped like a cap. Insert body 200 has an outer wall 201 (FIG. 3B), with an opening 203 at open end 202 and an opening 205 at open end 204. Outer wall 201 is curved slightly inward at open end 204 (FIGS. 3B and 3C). Outer wall 201 has a plurality of slight castellations 72 with rounded corners 73 along the edge of opening 205 (FIG. 3C). Sealing member 210 is attached to insert body 200 at open end 202 (FIG. 3D). Sealing member 210 has a side 211 (FIG. 3E) with an inward rib 212, which engages with an outward rib 208 on outer wall 201 at open end 202, forming a removable liquid proof snap closure.

FIGS. 3F to 3J show a two-piece container insert assembly 250 in use. An insert body 200 is mated with a nipple-collar assembly 50 by inserting open end 204 into opening 26 (FIG. 3F), forming a liquid-proof seal between open end 204 and neck 22. Insert body 200 and nipple-collar assembly 50 are inverted, and a material 62 is added through opening 203 (FIG. 3G). A sealing member 210 is attached to insert body 200 at open end 202, forming a container insert assembly 250 (FIG. 3H), and with nipple-collar assembly 50 material 62 is sealed. Nipple-collar assembly 50, with container insert assembly 250 and material 62, is mated to a bottle 10, which also contains a liquid 61 (FIG. 3I). This is the storage position for container insert assembly 250. Liquid 61 and material 62 cannot communicate and may be stored separately in this configuration, ready for mixing, for as long as the sterility of the environment in which it was prepared allows. When mixing is desired, nipple 20 is depressed with enough force to dislodge container insert assembly 250 from nipple 20 (FIG. 3J). Open end 204 is unsealed, allowing material 62 and liquid 61 to mix through opening 205. After agitating bottle assembly 60 the mixture can be administered.

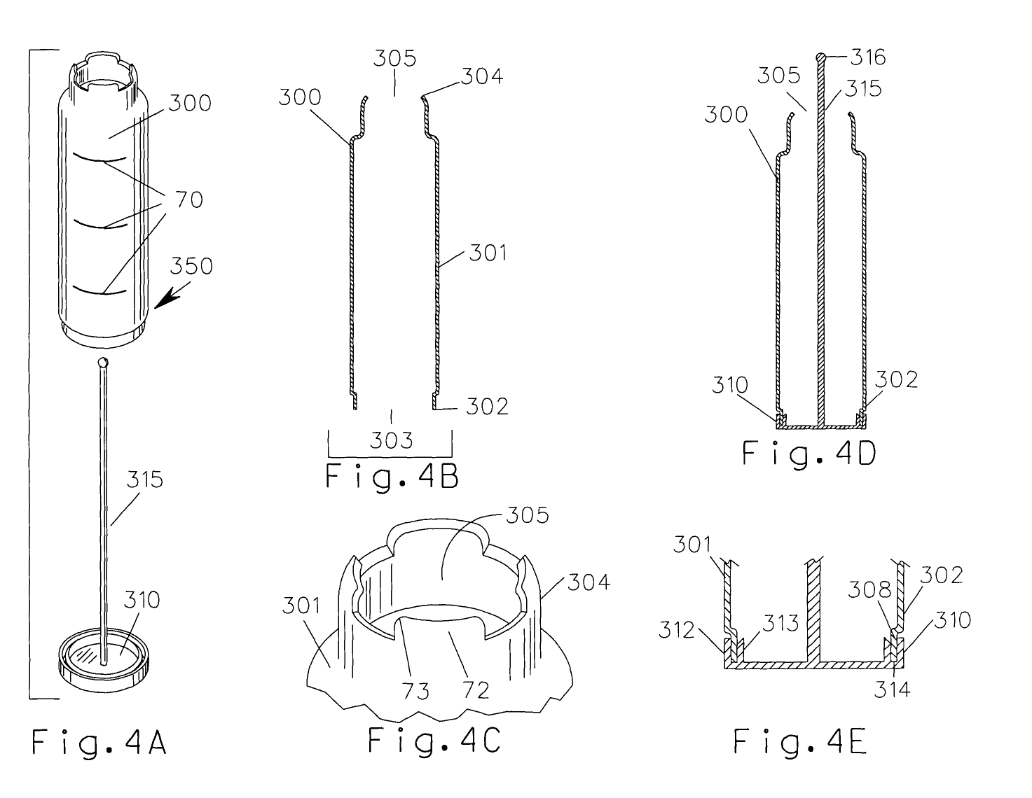

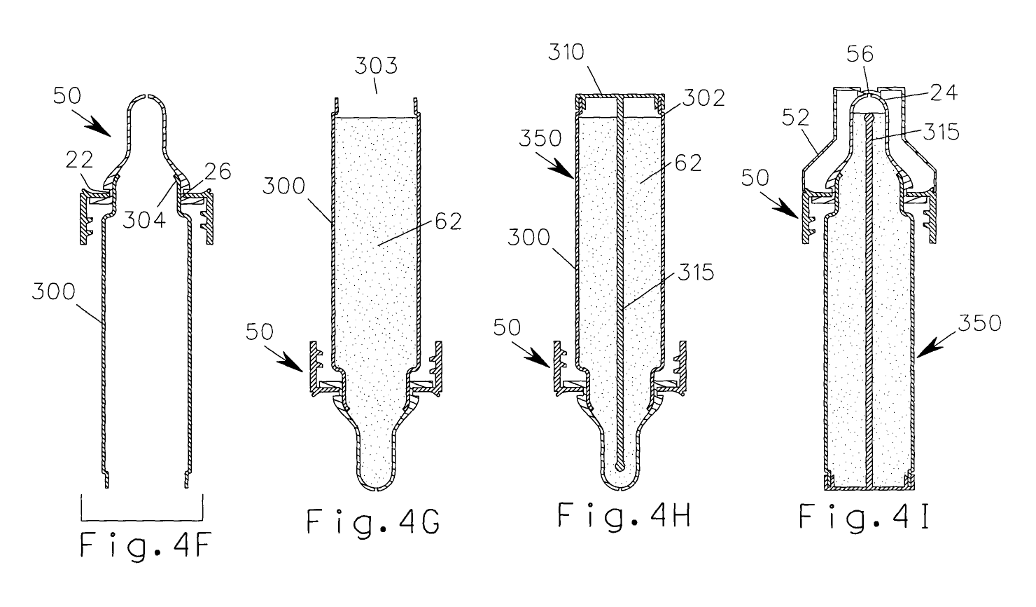

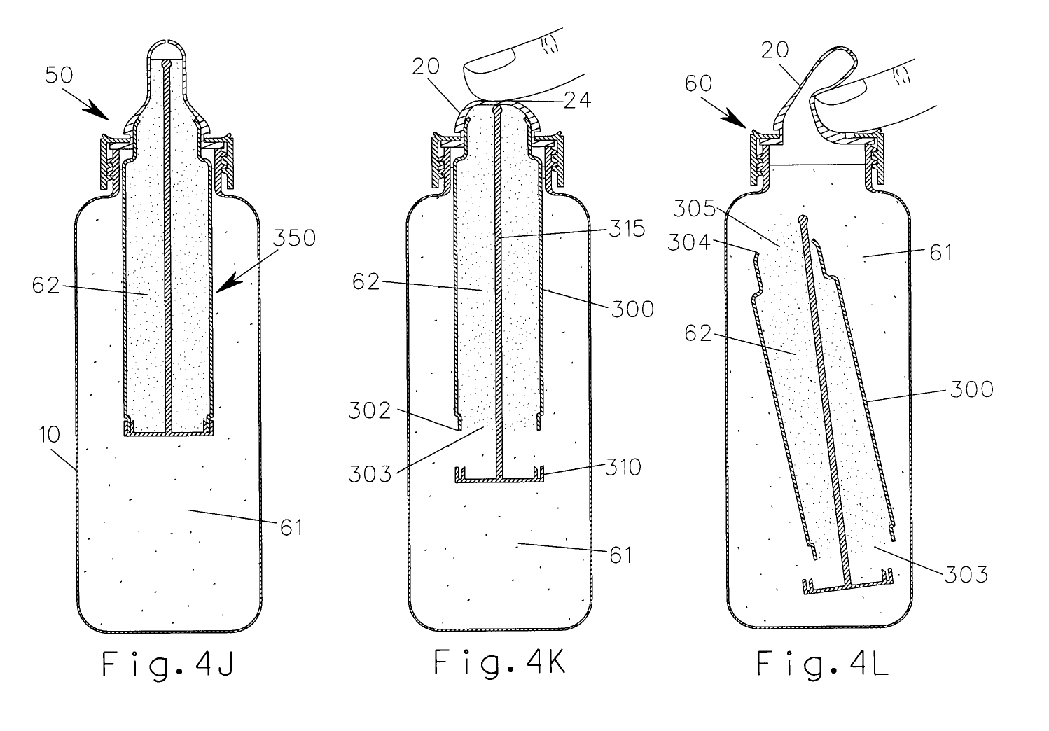

The preferred embodiment of the invention is shown in FIGS. 4A to 4E. A container insert assembly 350 (FIG. 4A), comprising an insert body 300 of hollow construction, cylindrical in shape, formed of plastic, preferably transparent, with a plurality of graduations 70 on the outside, and a sealing member 310 shaped like a cap with a pushrod 315 in the inside center. Insert body 300 has an outer wall 301 (FIG. 4B), with an opening 303 at open end 302 and an opening 305 at open end 304. Outer wall 301 is curved slightly inward at open end 304 (FIGS. 4B and 4C). Outer wall 301 has a plurality of slight castellations 72 with rounded corners 73 along the edge of opening 305 (FIG. 4C). Sealing member 310 is attached to insert body 300 at open end 302 (FIG. 4D). Pushrod 315, with a bulb 316 on its end, is long enough to protrude from opening 305. Outer wall 301 has a flange 308 at open end 302 (FIG. 4E), which seats in a groove 314 on sealing member 310, formed by a side 312 and a flange 313, providing a liquid-proof seal.

FIGS. 4F to 4L show a container insert assembly 350 in use. An insert body 300 is mated with a nipple-collar assembly 50 by inserting open end 304 into opening 26 (FIG. 4F), forming a liquid-proof seal between by open end 304 and neck 22. Insert body 300 and nipple-collar assembly 50 are inverted, and a material 62 is added through opening 303 (FIG. 4G). A sealing member 310 is attached to insert body 300 at open end 302, pushing pushrod 315 through material 62, forming a container insert assembly 350 (FIG. 4H), and with nipple-collar assembly 50, material 62 is sealed. When an optional cover 52 is attached to nipple-collar assembly 50 with container insert assembly 350 (FIG. 41), closed end 24, when slightly compressed by recess 56, should not come in contact with pushrod 315. Nipple-collar assembly 50, with container insert assembly 350 and material 62, is mated to a bottle 10, which also contains a liquid 61 (FIG. 43). This is the storage position for container insert assembly 350. Liquid 61 and material 62 cannot communicate and may be stored separately in this configuration, ready for mixing, for as long as the sterility of the environment in which it was prepared allows. When mixing is desired, closed end 24 of nipple 20 is depressed (FIG. 4K), exerting enough force on pushrod 315 to dislodge sealing member 310 from insert body 300. Open end 302 is unsealed, and material 62 and liquid 61 can mix through opening 303. Nipple 20 is depressed further to dislodge insert body 300 from nipple 20 (FIG. 4L). Open end 304 is also unsealed, allowing material 62 and liquid 61 to mix through both opening 305 and opening 303, facilitating a thorough mixing. After agitating bottle assembly 60 the mixture can be administered.

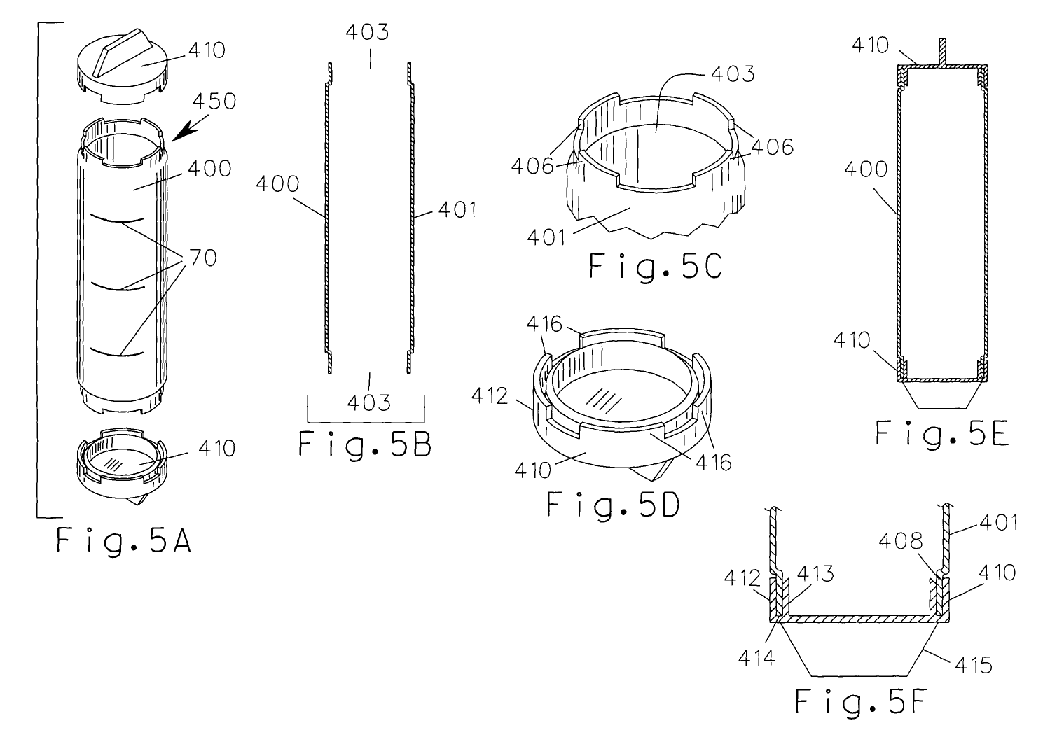

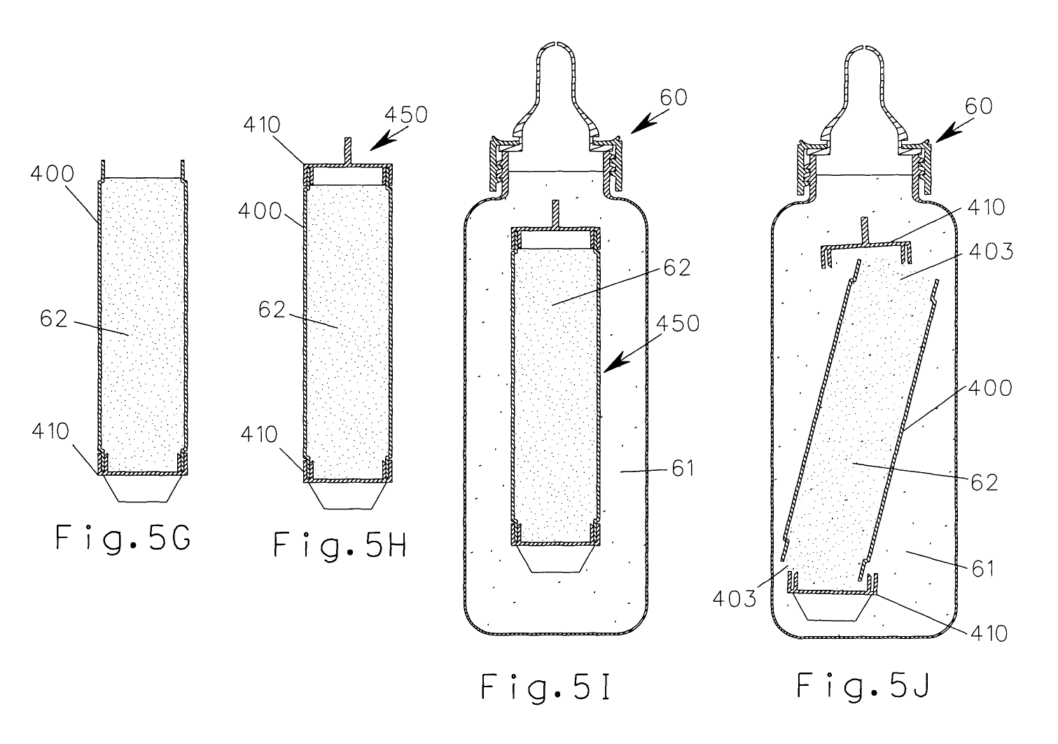

A three-piece example of the invention is shown in FIGS. 5A to 5F. A container insert assembly 450 (FIG. 5A), comprising an insert body 400 of hollow construction, cylindrical in shape, formed of plastic, preferably transparent, with a plurality of graduations 70 on the outside, and two sealing members 410 shaped like caps. Insert body 400 has an outer wall 401 (FIG. 5B) with an opening 403 at each end. Outer wall 401 has a plurality of slight castellations 406 along the edge of each opening 403 (FIG. 5C). Each sealing member 410 has a side 412 with a plurality of slight castellations 416 (FIG. 5D). Sealing members 410 are attached to insert body 400 at each end (FIG. 5E). Outer wall 401 has a flange 408 at both ends, each which seats in a groove 414 on a sealing member 410 (FIG. 5F), formed by side 412 and a flange 413, providing a liquid-proof seal. Each sealing member 410 has a fin 415 on the outside.

FIGS. 5G to 5J show the three-piece container insert assembly 450 in use. An insert body 400 is mated with a sealing member 410 at one end, and filled with a material 62 through the other (FIG. 5G). A second sealing member 410 is mated to the open end of insert body 400, forming a container insert assembly 450 (FIG. 5H) and sealing material 62. Container insert assembly 450, with material 62, is placed inside a bottle assembly 60, which also contains a liquid 61 (FIG. 5I). This is the storage position for container insert assembly 450. Liquid 61 and material 62 cannot communicate and may be stored separately in this configuration, ready for mixing, for as long as the sterility of the environment in which it was prepared allows. When mixing is desired, bottle assembly 60 is shaken with enough force to dislodge each sealing member 410 from insert body 400 (FIG. 5J). The ends of insert body 400 are unsealed, allowing material 62 and liquid 61 to mix through both openings 403. After agitating bottle assembly 60 mixture can be administered.

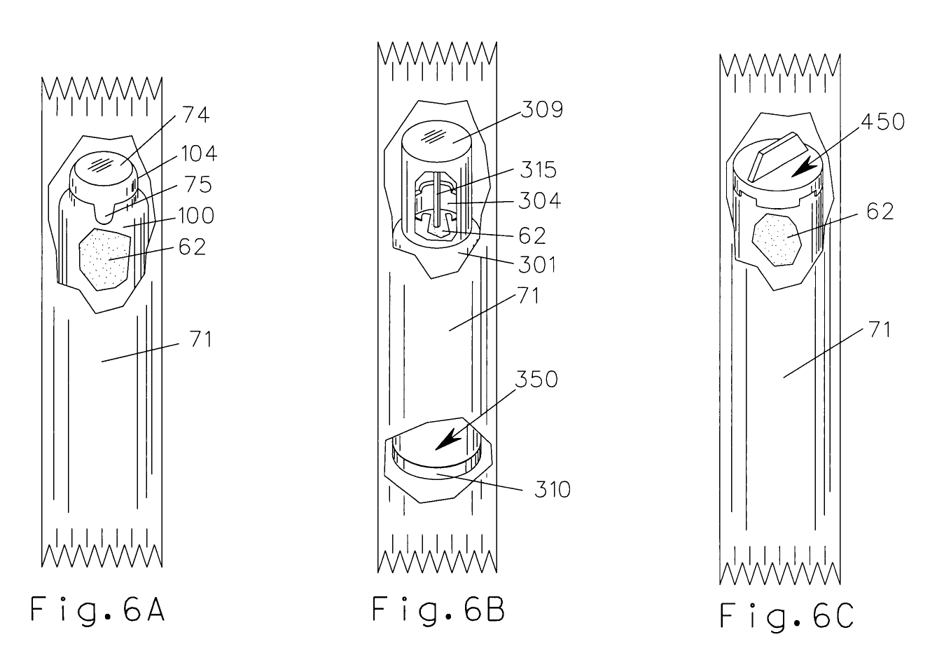

The container inserts can also be prepackaged for immediate use. FIG. 6A shows a container insert 100, filled with a material 62, with open end 104 sealed using a sealing member 74, and enclosed in a packaging 71. Sealing member 74 can be a cellophane diaphragm held in place using a non-permanent adhesive or heat bond such that sealing member 74 can be easily removed using a pull tab 75. Packaging 71 can be a foil wrapper. FIG. 6B shows a container insert assembly 350, filled with a material 62, with open end 304 sealed using a sealing member 309, and enclosed in a packaging 71. Sealing member 309, made of a suitable rigid plastic, is held in place by friction against outer wall 301, prevents an accidental force on pushrod 315 that might dislodge sealing member 310, and can easily be removed. FIG. 6C shows a container insert assembly 450, filled with a material 62, and enclosed in a packaging 71.

Accordingly, the reader will see that the container insert of this invention can be used to store a material separately inside a bottle, and release the material into the bottle when desired. Furthermore, the container insert has the additional advantages in that:
it permits the caregiver to prepare the bottle in a controlled environment, facilitating cleanliness and accurate measurements;
it permits the caregiver to mix the contents when desired without reopening the bottle, eliminating a significant chance of contamination;
it permits the caregiver to mix the contents quickly and with minimal attention, even one handed with tactile senses only;
its simple design allows ease of cleaning;
it works with bottles the caregiver already possesses.

Although the description above contains many specificities, these should not be construed as limiting the scope of the invention but as merely providing illustrations of some of the presently preferred embodiments of the invention. For example, the container insert body can be made of a bag to work with prior art bag-style bottles; the container insert can be used in bottles other than for feeding infants, including geriatric, invalid, and livestock care; the insert container can be shaped differently to accommodate different bottles.

Thus the scope of the invention should be determined by the appended claims and their legal equivalents, rather than by the examples given.

1. In combination with a bottle for feeding liquids which is of hollow construction with a nipple, a container insert comprising a body, hollow in construction with an open end to receive a material to be stored, which can be sealed by inserting said end into said nipple, whereby said container insert can store a measure of said material inside said bottle to be released into said bottle when desired.

2. The container insert as defined in claim 1 wherein said container insert receives one of a solid or a liquid material to be stored and released.

3. The container insert as defined in claim 1 wherein said material is released into said bottle by dislodging said end from said nipple.

4. The container insert as defined in claim 1 wherein said end has a plurality of castellations, whereby a dislodged container insert will not impede the flow of a liquid.

5. The container insert as defined in claim 1 wherein the body has a plurality of additional open ends with sealing members.

6. The container insert as defined in claim 5 wherein said additional open ends are unsealed by agitation.

7. The container insert as defined in claim 5 wherein said sealing members have a plurality of pushrods extending into said nipple.

8. The container insert as defined in claim 7 wherein said additional open ends are unsealed by exerting force on said pushrods through said nipple to dislodge said sealing members from the container insert body.

9. The container insert as defined in claim 8 wherein said sealing members require less force to be dislodged from the container insert body than the force required to dislodge the container insert body from said nipple.

10. The container insert as defined in claim 1 wherein said container insert is filled with a material, the end closed with a removable sealing member or nipple, and sealed in packaging, whereby said container insert can be prepackaged for immediate use.

11. In combination with a bottle for feeding liquids which is of hollow construction, a container insert comprising a body, hollow in construction to receive a material to be stored, with a plurality of open ends with sealing members, whereby said container insert can store a measure of said material inside said bottle, to be released into said bottle when desired.

12. The container insert as defined in claim 11 wherein said container insert receives one of a solid or a liquid material to be stored and released.

13. The container insert as defined in claim 11 wherein said open ends are unsealed by agitation.

14. The container insert as defined in claim 11 wherein said open ends are unsealed by dislodging said insert container from a nipple.

15. The container insert as defined in claim 11 wherein the parts of said container insert have a plurality of castellations, whereby a dislodged container insert part will not impede the flow of a liquid.

16. The container insert as defined in claim 11 wherein said sealing members have a plurality of pushrods extending into a nipple.

17. The container insert as defined in claim 16 wherein said open ends are unsealed by exerting force on said pushrods through said nipple to dislodge said sealing members from the container insert body.

18. The container insert as defined in claim 11 wherein the container insert body has a plurality of pushrods extending into a nipple.

19. The container insert as defined in claim 18 wherein said open ends are unsealed by exerting force on said pushrods through said nipple to dislodge the container insert body from said sealing members.

20. The container insert as defined in claim 11 wherein said container insert is filled with a material and sealed in packaging, whereby said container insert can be prepackaged for immediate use.
